(19) United States
(12) Patent Application Publication
(10) Pub. No.: US 2016/0185648 A1
(43) Pub. Date: Jun. 30, 2016

(54) MANUFACTURING OF WAFER-LIKE THIN GLASS PLATES HAVING STRUCTURES THEREON AND SEPARATION THEREOF INTO INDIVIDUAL SMALLER THIN GLASS PLATES

(71) Applicant: SCHOTT AG, Mainz (DE)

(72) Inventor: Matthias JOTZ, Alfeld (DE)

(73) Assignee: SCHOTT AG, Mainz (DE)

(21) Appl. No.: 14/956,160

(22) Filed: Dec. 1, 2015

(30) Foreign Application Priority Data
Dec. 1, 2014 (DE) 10 2014 117 630.8

(51) Int. Cl. C03B 33/09; B26F 3/00; C03B 33/023

(52) U.S. Cl. CPC C03B 33/09; C03B 33/023; C03B 33/091; B26F 3/002

(57) ABSTRACT

A method for manufacturing wafer-like thin glass plates having structures thereon and for separating the wafer-like thin glass plates into individual smaller thin glass plates is provided. The method includes the steps of: providing thin glass in wafer size, having an upper surface and a lower surface; producing scorings in the lower surface of the thin glass using a mechanical scoring tool in order to delimit individual smaller thin glass plates from each other; applying structures on the upper surfaces of the individual smaller thin glass plates; applying a blasting liquid to form a moisture film on the thin glass thereby wetting the scorings; and heating the moisture film until it evaporates at least partially thereby causing cleaving of the scorings and singulation of the thin glass into the individual smaller thin glass plates having fresh break edges.

### CROSS REFERENCE TO RELATED APPLICATIONS

This application claims the benefit under 35 U.S.C. § 119(a) of German Patent Application No. 10 2014 117 641.3 filed Dec. 1, 2014 and German Patent Application No. 10 2015 108 061.3 filed May 21, 2015, the entire content of both of which are incorporated herein by reference.

### BACKGROUND

1. Field of the Invention

The present invention relates to a method for manufacturing wafer-like thin glass plates equipped with structures and to the separation thereof into individual smaller thin glass plates, and also relates to thin glass plates produced by such method.

The term “structures” refers to any structure which has been applied to the individual smaller thin glass plates. This includes deposition, etching, coating, roughening, and other processing measures known in microtechnology, and also includes the mounting of components for equipping chips.

In the context of the present application, thin glass refers to thin glass in wafer size that has a wall thickness of less than 1.2 mm, however, a minimum thickness must be observed, which can be found by trial and error for each respective application. Toughened glasses may be used as well.

2. Description of Related Art

Application areas of the individual smaller thin glass plates include biotechnology, medical technology, electrical engineering, electronics, and power supply of small appliances using electric batteries, in particular lithium-ion batteries. Such lithium-ion batteries are available with solid electrolytes, inter alia, which are nowadays produced in particular in the form of so-called thin film batteries (TFB), or thin film storage elements. Such batteries are used especially in mobile applications, for example in so-called smart cards, in smart phones, in sensor technology, and in medical technology, and anywhere where smart miniaturized or flexible energy sources are required.

For manufacturing thin film batteries and thin film storage elements, layers are deposited on substrates, which layers generally have a thickness in a range around 20 μm, or of less than 10 μm or even less than 5 μm. The total thickness of the layered structure is 100 μm or less.

A thin film storage element is produced by coating processes, comprising, inter alia, deposition of patterned materials associated with functionality. Particular difficulties are encountered in lithium-based thin film storage elements due to the use of metallic lithium as an anode material, because the latter exhibits high reactivity, especially to water. Therefore, when manufacturing lithium-based thin film storage elements, water-free conditions have to be ensured during handling.

### SUMMARY

The invention is based on the object to provide a method which is suitable for producing wafer-like thin glass plates and separating them into individual smaller thin glass plates equipped with structures. In particular, these individual small thin glass plates equipped with structures are intended to form components of thin film storage elements.

According to the invention, the thin glass is provided in wafer size, and the lower surface is scored with a pattern so that individual smaller thin glass plates are delimited from each other. These individual smaller thin glass plates are equipped, on the upper surface thereof, with structures associated with biological, medical technology, electrical, electronic, or power supply components. In order to obtain, from the wafer size, the smaller size thin glass plates equipped with structures, the scorings delimiting the smaller thin glass plates are wetted with a blasting liquid. Subsequently, the moisture film on the thin glass is heated until it evaporates at least partially, with the result of cleaving the scorings and singulating the wafer size thin glass into the smaller size thin glass plates equipped with structures.

Furthermore according to the invention, thin glass with a fire-polished surface is employed to form substrates for thin film storage elements. A fire-polished surface is very smooth (with a roughness Rₐ of less than 1 nm) and ensures uniform application of layers on the substrates having a fire-polished surface. This is of great importance in the manufacturing of thin film storage elements.

Of equal importance for thin film storage elements is to use substrates that have a small thickness variation, since the layers to be deposited shall be very thin and the total thickness of the layered structure shall be maintained at small tolerances of variation, in order to be able to produce thin film storage elements of a series having the same characteristics. Therefore, it is preferred to use thin glass with a thickness variation in a range from <25 μm to <5 μm as a substrate.

### DESCRIPTION OF THE DRAWINGS

The invention will now be explained with reference to schematic drawings, wherein:

FIG. 1 shows thin glass in wafer size while scorings are produced;

FIG. 2 shows thin glass equipped with structures;

FIG. 3 shows the application of a moisture film onto the scored thin glass;

FIG. 4 shows the heating of the liquid film applied on the thin glass and the bursting into small thin glass plates;

FIG. 5 is a sectional view through a portion of the thin glass equipped with structures on prepared small thin glass plates during cleaving of the scorings; and

FIG. 6 shows a scoring head with a scoring tool and feed of blasting liquid.

### DETAILED DESCRIPTION

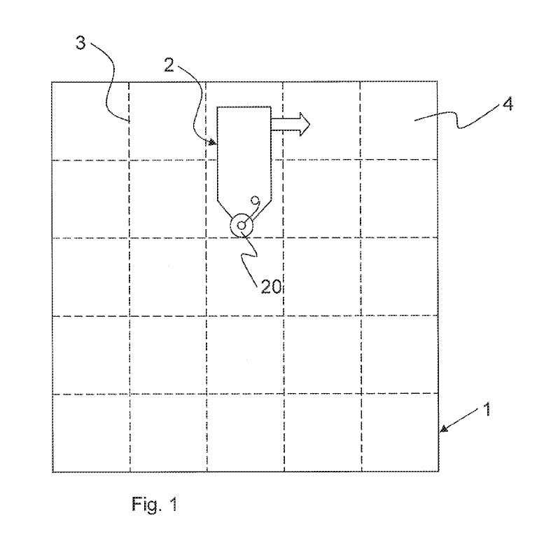

Referring to FIG. 1, thin glass 1 in wafer size is schematically shown, together with a scoring head 2 with a scoring tool 20 while producing scorings 3. In reality the scoring head 2 with scoring tool 20 would, of course, be placed vertically on the wafer size thin glass. Scorings 3 are intended to form a grid of scorings delimiting individual fields from each other and defining marks for division of the wafer size thin glass into individual thin glass plates 4. Once the scorings 3 have been produced, the thin glass 1 is prepared for being separated into the individual smaller thin glass plates 4.

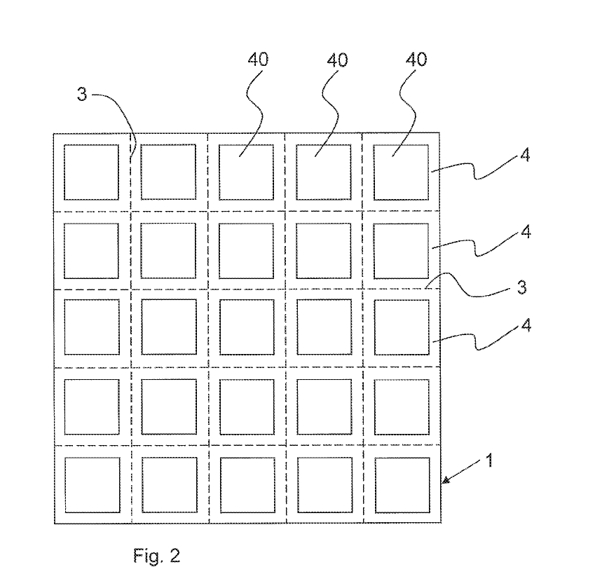

FIG. 2 shows wafer size thin glass 1 divided according to a pattern, and the individual fields formed by the smaller thin glass plates 4 are equipped with structures 40 comprising small functional appliances or forming parts of biological, medical technology, electrical, electronic, or power generating components, or may comprise test components. Accordingly, the term “structures” is a general term that may as well refer to coatings or other types of processing as employed in microtechnological processing, such as depositing and patterning of layers. For example, in the case of lithium batteries, several layers of lithium and solid electrolyte are deposited in thin layers in an alternating sequence to produce the active portion of lithium-ion batteries. The term “equipping” has to be understood in its most general meaning, comprising both, the application of structures 40 in one piece, and sequential application by processing steps.

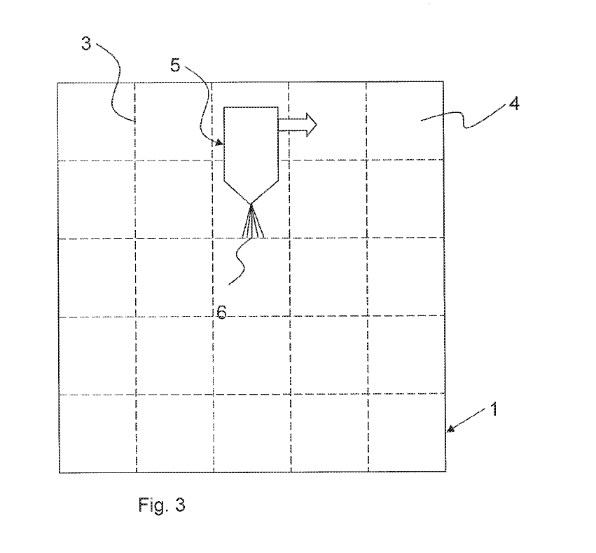

FIG. 3 schematically illustrates the application of a blasting liquid 6 to form a moisture film. For this purpose, a spray head 5 is provided, which is displaceable along scorings 3 and emits blasting liquid 6 onto the scorings. The blasting liquid 6 has the property of wetting the glass and therefore will be drawn into the scorings 3 as a result of capillary action. Depending on the processing procedure, structures 40 may be applied before or after the wetting of scorings 3. It is preferred to produce scorings 3 on the lower surface and to apply the structures 40 on the upper surface of the thin glass.

In experiments that have been carried out, glasses of a minimum thickness of 400 μm and 700 μm have been processed successfully.

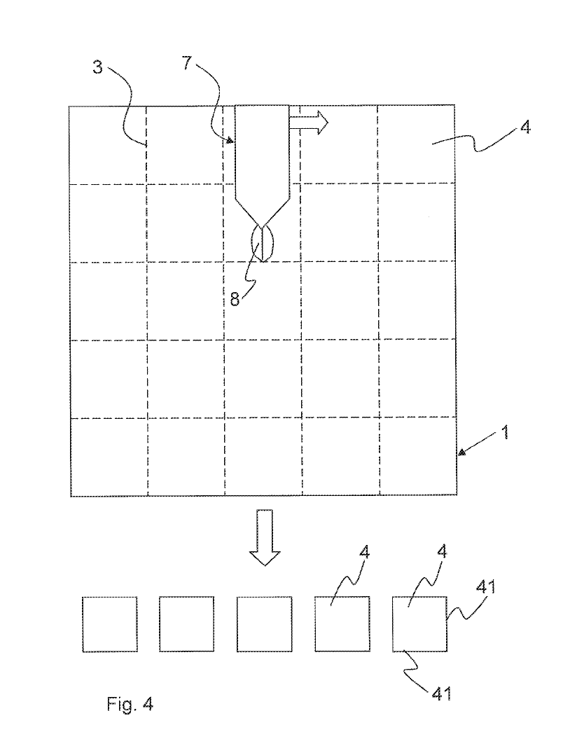

FIG. 4 schematically illustrates the process of separating the smaller thin glass plates 4 from the larger wafer size thin glass 1. A burner head 7 emits a fine flame 8 whose tip is directed along the scorings 3 on the lower surface of thin glass 1 to locally heat the thin glass 1 there and to cause the blasting liquid 6 to evaporate. The resulting disruptive power in scorings 3 cleaves and divides the wafer size thin glass 1 into the individual smaller thin glass plates 4, which is schematically illustrated in the lower half of the figure.

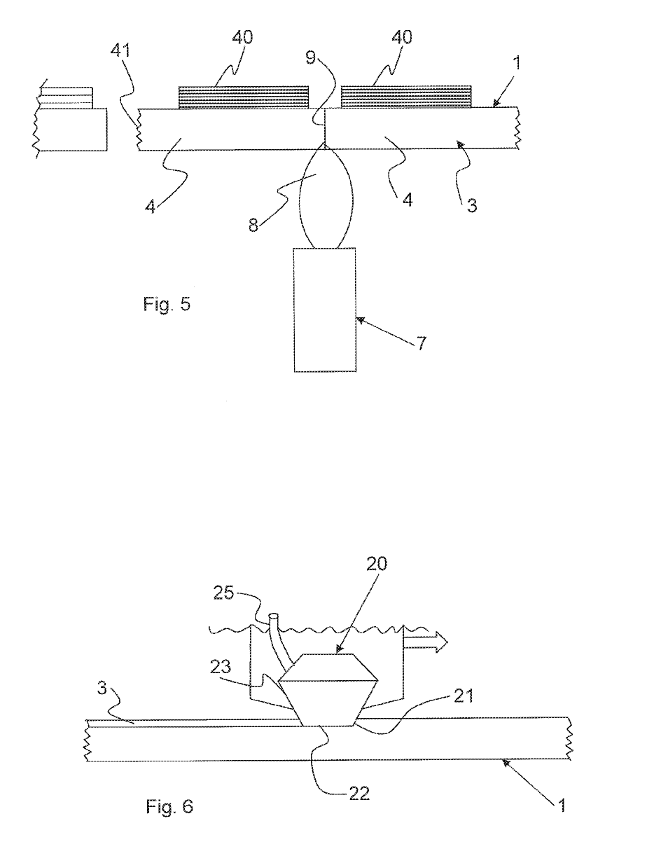

FIG. 5 illustrates the separating and singulating of the smaller thin glass plates 4 from thin glass 1. Thin glass 1 has been wetted with a blasting liquid 6, at least in the region of scorings 3, which blasting liquid does not react with the structures 40. Now, when the blasting liquid 6 evaporates within scorings 3 by the impact of the heat from flame 8, a disruptive effect will be caused and cracks 9 will be produced in the thin glass 1 propagating along a respective scoring 3, which cracks 9 will extend through the thin glass 1 and lead to a separation into the individual thin glass plates 4. Thereby, fresh break edges 41 are produced on the thin glass.

FIG. 6 schematically shows how scorings 3 are produced in the thin glass 1. Scoring head 2 comprises mechanical scoring tool 20 in form of a cut diamond that has a front bow cutting edge 21, a lower bottom cutting edge 22, and a rear side 23. A passage 25 extends to the rear side 23 and feeds blasting liquid into the scoring 3 produced by the scoring tool thereby wetting the scoring with blasting liquid.

While the schematic drawings indicate a single scoring head and a single burner head, a plurality of assemblies will be provided in practice to simultaneously produce and cleave a plurality of scorings.

When the thin glass 1 is separated, as shown in FIG. 4, individual thin glass plates 4 are produced which are bounded by fresh break edges 41. In conjunction with the present invention it is possible to conserve these fresh break edges 41, that means to coat them with a protective film of a sizing mixture. Suitable sizing mixtures are known and include alcohol and wax, for example.

With alcohol substance and wax substance it is moreover possible to produce a sizing mixture which may serve as a blasting liquid as well. Accordingly, if sizing mixture is spray-deposited as the blasting liquid 6, as shown in FIG. 3, the alcohol substance will behave as a wetting agent and as a disruptive power generating agent when heated according to FIG. 4 or 5. Due to the impact of heat the wax substance will melt and coat the fresh break edges 41 of the thin glass plates 4 with a protective wax layer.

As an alternative to heating the moisture film using fine flames it is also possible to direct electromagnetic radiation to the scorings 3 defining the grid pattern to separate the equipped thin glass plates.

If structures 40 do not react with water and are resistant, water may be used as well as the blasting liquid, especially since the latter penetrates into the scorings 3 in the thin glass 1 particularly easily and develops a large disruptive effect. Particularly suitable is an aqueous liquid which contains an organic ionic compound consisting of a cation having a positively charged nitrogen atom and a hydroxyl ion as an anion.

What is claimed is:

1. A method for manufacturing wafer-like thin glass plates having structures thereon and for separating the wafer-like thin glass plates into individual smaller thin glass plates, comprising the steps of:
providing thin glass in wafer size, having an upper surface and a lower surface;
producing scorings in the lower surface of the thin glass using a mechanical scoring tool in order to delimit individual smaller thin glass plates from each other;
applying structures on the upper surfaces of the individual smaller thin glass plates;
applying a blasting liquid to form a moisture film on the thin glass thereby wetting the scorings; and
heating the moisture film until it evaporates at least partially thereby causing cleaving of the scorings and singulation of the thin glass into the individual smaller thin glass plates having fresh break edges.

2. The method as claimed in claim 1, wherein the step of providing the thin glass comprises thin glass having a fire-polished surface suitable to form substrates for thin film storage elements.

3. The method as claimed in claim 2, wherein the thin glass has a thickness variation in a range of <25 μm.

4. The method as claimed in claim 2, wherein the thin glass has a thickness variation in a range <5 μm.

5. The method as claimed in claim 1, wherein the mechanical scoring tool comprises diamond cutting edges.

6. The method as claimed in claim 1, wherein the step of heating comprises heating the moisture film only locally, along the scorings.

7. The method as claimed in claim 1, wherein the step of heating comprises directing a flame at the scorings.

8. The method as claimed in claim 1, wherein the step of heating comprises directing electromagnetic radiation at the scorings.

9. The method as claimed in claim 1, wherein the step of applying a blasting liquid comprises feeding the blasting liquid through a passage into the scorings.

10. The method as claimed in claim 1, further comprising coating the fresh break edges with a protective film of a sizing mixture.

11. The method as claimed in claim 9, wherein the sizing mixture includes an alcohol substance and/or a wax substance.

12. The method as claimed in claim 1, wherein the blasting liquid is a substance that does not react with structures applied on the thin glass.

13. The method as claimed in claim 1, wherein the blasting liquid comprises an aqueous liquid including an organic ionic compound.

14. The method as claimed in claim 1, further comprising including a structure that includes thin film storage elements on the thin glass.

15. The method as claimed in claim 14, wherein the step of providing thin glass comprises providing thin glass that has a fire-polished surface and a thickness variation in a range between <24 μm and <5 μm.
